(19) United States
(12) Patent Application Publication
(10) Pub. No.: US 2023/0266551 A1
(43) Pub. Date: Aug. 24, 2023

(54) SPACE EFFICIENT OPTICAL FIBER TRAY ORGANIZER FOR A TELECOMMUNICATIONS CLOSURE

(71) Applicant: CommScope Technologies LLC, Hickory, NC (US)

(72) Inventors: Bart Mattie CLAESSENS, Hasselt (BE); El Moiz Mohammed Michel GHAMMAM, Brussels (BE)

(21) Appl. No.: 18/309,252

(22) Filed: Apr. 28, 2023

Related U.S. Application Data
(63) Continuation of application No. PCT/US2021/056016, filed on Oct. 21, 2021.
(60) Provisional application No. 63/107,497, filed on Oct. 30, 2020.
(60) Provisional application No. 63/160,118, filed on Mar. 12, 2021.

(51) Int. Cl. G02B 6/44

(52) U.S. Cl. CPC G02B 6/44524; G02B 6/44526

(57) ABSTRACT

An organizer for an optical fiber closure. The organizer includes a module or a stack of modules that pivotally support fiber management trays and accommodate differently sized trays in a space efficient manner. In some embodiments, the modules include groups of tray couplers that are spaced apart from each other along the stack's stacking axis. In some embodiments, the modules include tray couplers that pivotally support fiber management trays in a stepped configuration, such that the pivot axes defined by adjacent tray couplers align non-parallel to the stack's stacking axis.

### CROSS-REFERENCE TO RELATED APPLICATIONS

This application is a Continuation of International Patent Application No. PCT/US2021/056016, filed on Oct. 21, 2021, which claims the benefit of U.S. Patent Application Ser. No. 63/107,497, filed on Oct. 30, 2020, and claims the benefit of U.S. Patent Application Ser. No. 63/160,118, filed on Mar. 12, 2021, the disclosures of which are incorporated herein by reference in their entireties. To the extent appropriate, a claim of priority is made to each of the above disclosed applications.

### TECHNICAL FIELD

The present disclosure relates to the management of optical fiber connections, and in particular, to an organizer assembly that holds fiber optic trays.

### BACKGROUND

Optical fibers of optical fiber cables can be managed within a telecommunications closure using a fiber management assembly. Some management assemblies include fiber management trays pivotally mounted to a support structure. The support structure can include features that facilitate routing of cables and fibers onto and off of the trays. The support structure and trays can include various cable and fiber guides, guide walls, and retaining tabs for guiding incoming and outgoing fibers to and from the telecommunications closure. The fiber management trays can accommodate different fiber management operations and arrangements, such as supporting splice bodies, storing fiber slack, supporting signal splitters, supporting optical fiber connectors and adapters, and so forth. The trays are pivotally mounted to the support structure to facilitate access to the management features of a desired tray.

It is generally desirable to minimize unused or unusable space within a telecommunications closure, and to minimize one or more of the external dimensions of a telecommunications closure.

### SUMMARY

In general terms, the present disclosure is directed to a module or modules of an optical fiber management organizer of an optical fiber closure that has features that, for a given number of fiber management trays pivotally supported by the optical fiber management organizer, reduces the maximum required dimensions of the closure's base.

In general terms, modules of the present disclose are configured to mount fiber management trays such that a length of a stack of the trays is increased along a stacking axis while the projection of the stack of the trays in a plane perpendicular to the stacking axis is reduced.

Advantageously, the modules of the present disclosure can allow for telecommunications closures (e.g., optical fiber closures) such as dome closures, in which a dimension of a base piece of the closure through which cables enter the closure volume is minimized while accommodating the same number of fiber management trays as a closure with a larger base piece.

In some examples, a dimension of the base piece and a dimension of a dome cover piece are reduced, while another dimension of the dome cover piece is increased.

Optical fiber closures with reduced base dimensions can, e.g., be easier to fit, position and maneuver in relatively small spaces. In addition, optical fiber closures with reduced base dimensions can reduce the weight per unit longitudinal length of a given closure, which can allow for improved weight distribution of an aerially suspended closure.

Aspects of the modules of the present disclosure can advantageously accommodate and be compatible with stacking arrangements of different sizes of fiber management trays (e.g., thinner fiber management trays that accommodate non-ribbonized loose fibers and thicker fiber management trays that accommodate ribbonized fibers) in a closure having a base of reduced profile.

According to certain aspects of the present disclosure, an optical fiber organizer for an optical fiber closure, includes: modules, the modules configured to be stackably connected together along a stacking axis to form a stack of the modules, each of the modules including a body defining tray couplers, each of the tray couplers being adapted to pivotally mount, about a pivot axis, an optical fiber management tray, at least one of the modules being configured such that a first reference line perpendicular to, and extending through, at least two of the pivot axes of the one of the modules is oblique to the stacking axis.

According to further aspects of the present disclosure, an optical fiber organizer for an optical fiber closure, includes: a module defining a first axis extending between a bottom of the module and a top of the module, a second axis extending between a left side of the module and a right side of the module, and a third axis extending between a front of the module and a back of the module, the first axis, the second axis, and the third axis being mutually perpendicular to one another, the module including a body defining tray couplers, each of the tray couplers being adapted to pivotally mount, about a pivot axis, an optical fiber management tray, the tray couplers being arranged in groups, each of the groups including at least two of the couplers, adjacent groups being separated from each other parallel to the first axis, adjacent tray couplers of adjacent groups being separated parallel to the first axis by a greater distance than adjacent tray couplers of the same group.

According to further aspects of the present disclosure, an optical fiber organizer for an optical fiber closure, includes: a module defining a first axis extending between a bottom of the module and a top of the module, a second axis extending between a left side of the module and a right side of the module, and a third axis extending between a front of the module and a back of the module, the first axis, the second axis, and the third axis being mutually perpendicular to one another, the module including a body defining tray couplers, each of the tray couplers being adapted to pivotally mount, about a pivot axis, an optical fiber management tray, the module being configured such that a first reference line perpendicular to, and extending through, at least two of the pivot axes of the module is oblique to the first axis.

According to further aspects of the present disclosure, an optical fiber organizer for an optical fiber closure, includes: a module defining a first axis extending between a bottom of the module and a top of the module, a second axis extending between a left side of the module and a right side of the module, and a third axis extending between a front of the module and a back of the module, the first axis, the second axis, and the third axis being mutually perpendicular to one another, the module including a body defining tray couplers, each of the tray couplers being adapted to pivotally mount, about a pivot axis, an optical fiber management tray; fiber management trays pivotally coupled to the tray couplers; wherein when the fiber management trays are in a downward most pivot position, each of the fiber management trays forms an angle with the first axis, the angle lying in a vertical plane that is parallel to the third axis, the angle being less than 45 degrees and greater than 0 degrees.

According to further aspects of the present disclosure, an optical fiber organizer for an optical fiber closure, includes: a module defining a first axis extending between a bottom of the module and a top of the module, a second axis extending between a left side of the module and a right side of the module, and a third axis extending between a front of the module and a back of the module, the first axis, the second axis, and the third axis being mutually perpendicular to one another, the module including a body defining tray couplers, each of the tray couplers being adapted to pivotally mount, about a pivot axis, an optical fiber management tray, the tray couplers being arranged in groups, each of the groups including a pair of the tray couplers, wherein a minimum pitch parallel to the first axis between adjacent tray couplers in each pair is at least 7 millimeters.

According to further aspects of the present disclosure, an optical fiber organizer for an optical fiber closure, includes: a first fiber management component including a substantially T-shaped projection and one of a lip or a resilient arm having a catch; and a second fiber management component including an opening and the other of a lip or a resilient arm having a catch, the first fiber management component and the second fiber management component being configured to lockingly engage each other by sliding the T-shaped projection within the opening towards a narrow portion of the opening and snappingly engaging the lip and the catch.

According to further aspects of the present disclosure, an optical fiber organizer for an optical fiber closure, includes: a first fiber management component including two substantially T-shaped projections and a resilient arm having a catch; and a second fiber management component including two openings and a lip, the first fiber management component and the second fiber management component being configured to lockingly engage each other by sliding the T-shaped projections within the openings and towards narrow portions of the openings and snappingly engaging the lip and the catch.

According to further aspects of the present disclosure, a module of an optical fiber organizer, the module being configured to pivotally mount fiber management trays, includes: a group of tray couplers arranged such that a first coupler arrangement has two spaced apart clips and a second coupler arrangement has a single clip below and centered relative to the clips of the first arrangement.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a perspective view of an example optical fiber closure in a sealed configuration and holding an optical fiber organizer in accordance with the present disclosure.

FIG. 2 is a front view of an optical fiber organizer according to the present disclosure and including a fiber routing block connected thereto.

FIG. 3 is a front view of the fiber routing block of FIG. 2.

FIG. 4 is a perspective view of an optical fiber organizer according to the present disclosure, and including trays having a form factor that is different from the form factor of the trays of FIG. 2.

FIG. 5 is a further perspective view of the optical fiber organizer of FIG. 4.

FIG. 6 is a back view of the optical fiber organizer of FIG. 4.

FIG. 7 is a partially exploded view of the optical fiber organizer of FIG. 4.

FIG. 8 is a perspective of view of one of the tray supporting modules of the optical fiber organizer of FIG. 4.

FIG. 9 is a further perspective view of the tray supporting module of FIG. 8.

FIG. 10 is a perspective view of another of the tray supporting modules of the optical fiber organizer of FIG. 4.

FIG. 11 is a further perspective view of the tray supporting module of FIG. 9.

FIG. 12 is a front view of a portion of the optical fiber organizer of FIG. 4.

FIG. 13 is an enlarged, front view of a portion of the optical fiber organizer of FIG. 4.

FIG. 14 is an enlarged, perspective view of a portion of the optical fiber organizer of FIG. 4.

FIG. 15 is a perspective view of one of the fiber management trays of the optical fiber organizer of FIG. 4.

FIG. 16 is a further perspective view of the tray of FIG. 15.

FIG. 17 is an enlarged perspective view of a portion of the optical fiber organizer of FIG. 4.

FIG. 18 is a side view of the optical fiber organizer of FIG. 4.

FIG. 19 is a side, cross-sectional view of the optical fiber organizer of FIG. 4 along the line 19-19 in FIG. 12 and including fiber management trays having the form factor of the trays of FIG. 4 in a pivoted down position.

FIG. 20 is a side, cross-sectional view of the optical fiber organizer of FIG. 4 along the line 20-20 in FIG. 12 and including fiber management trays having the form factor of the trays of FIG. 4 in a pivoted down position.

FIG. 21 is a perspective view of the optical fiber organizer of FIG. 4, and including differently configured fiber management trays than the fiber management trays of FIG. 4, the trays having the form factor of the trays of FIG. 2.

FIG. 22 is an enlarged perspective view of a portion of the optical fiber organizer of FIG. 21.

FIG. 23 is a perspective view of one of the fiber management trays of FIG. 21.

FIG. 24 is a further perspective view of the fiber management tray of FIG. 23.

FIG. 25 is a side view of the portion of the optical fiber organizer of FIG. 21.

FIG. 26 is a side, cross-sectional view of the optical fiber organizer of FIG. 21 along the line 26-26 in FIG. 12 and including fiber management trays having the configuration of the trays of FIG. 21 in a pivoted down position.

FIG. 27 is a side, cross-sectional view of the optical fiber organizer of FIG. 21 along the line 27-27 in FIG. 12 and including fiber management trays having the configuration of the tray of FIG. 21 in a pivoted down position.

FIG. 28 is a perspective view of the optical fiber organizer of FIG. 21, showing one of the fiber management trays in a pivoted up position and the other fiber management trays in a pivoted down position.

FIG. 29 is a perspective view of a portion of the module support structure of the assembly of FIG. 2.

FIG. 30 is a rear view of a portion of the module support structure of FIG. 29.

FIG. 31 is a perspective view of a further portion of the assembly of FIG. 2.

FIG. 32 is a perspective view of a further portion of the assembly of FIG. 2.

FIG. 33 is a perspective view of a further portion of the module support structure of FIG. 29.

FIG. 34 is a perspective view of a further example fiber management assembly including components having mounting features of the present disclosure.

FIG. 35 is a perspective view of a subassembly of FIG. 34, including the module support structure and modules adapted to mount fiber management trays, the modules being mounted to the module support structure.

FIG. 36 is an enlarged perspective view of a portion of the subassembly of FIG. 35.

FIG. 37 is an enlarged perspective view of a further portion of the subassembly of FIG. 35.

FIG. 38 is a perspective view of a portion of the module support structure of the subassembly of FIG. 35.

FIG. 39 is a perspective view of the module support structure of the subassembly of FIG. 35.

FIG. 40 is a perspective view of the fiber routing block of the assembly of FIG. 34.

FIG. 41 is a view of a portion of the assembly of FIG. 34.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Any examples set forth in this specification are not intended to be limiting and merely set forth some of the many possible embodiments for the claimed invention.

As used herein, terms such as front, forward, back, rear, rearward, horizontal, vertical, top, bottom, upper, lower, and so forth are used as a description aid in relating positioning and orientation of components to one another within an assembly. These terms do not limit how any assembly or component of an assembly may be situated in practice.

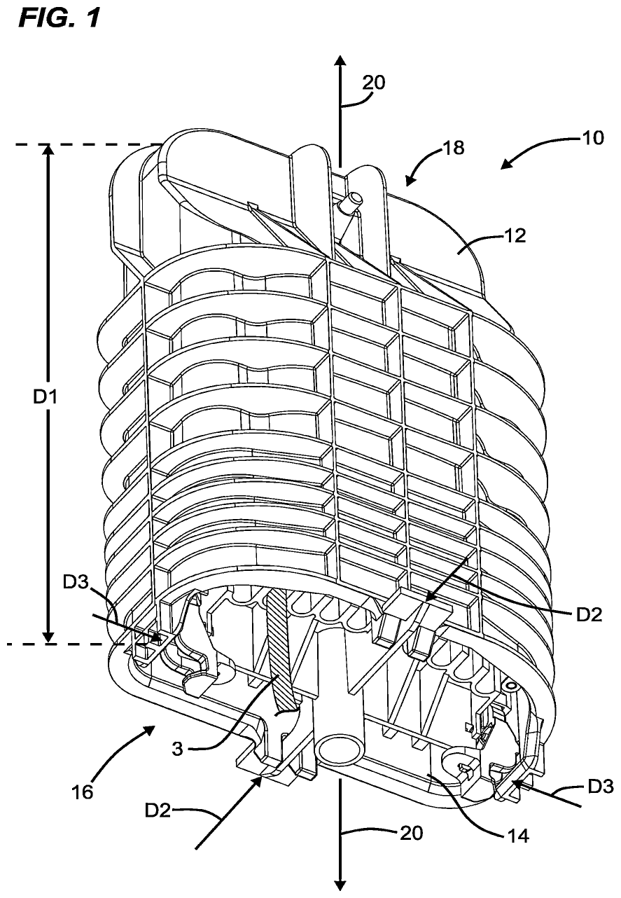

FIG. 1 shows an example prior telecommunications closure 10 that can house an optical fiber organizer (or, simply, organizer) within a closure volume. The closure 10 includes housing pieces, including a dome cover 12 and a base 14. The dome cover 12 and base 14 are configured to cooperate to a provide sealable and re-enterable closure volume in which the organizer can be housed. In some examples, the organizer is attached to an interior of the base 14 and is removed together with the base in order to, e.g., manage optical fibers on the organizer. The base 14 defines ports through which cables (e.g. the cable 3) can sealingly enter the closure volume. The example cable 3 includes optical fibers.

In some examples, end portions of the cables are fixated within the closure volume, and outer layers of the cables are removed to expose the optical fibers which can then be routed on the organizer. For example, a fiber from a network provider side cable can be spliced to a fiber of a subscriber side cable and the splice can be supported on a fiber management tray of the organizer. In another example, a connectorized fiber from a network provider side cable can be optically connected to a connectorized fiber of a subscriber side cable and the optical connectors and connection mechanism (e.g., an adapter) can be supported by the organizer, such as on a fiber management tray. Other fiber management operations, such as fiber storage, connector storage, signal splitting, wave division multiplexing, indexing, and so forth can be performed using components and features of the organizer.

The closure 10 can be positioned and secured in the field in any desirable manner, such as lying in a manhole or aerially suspended from a power line or cable, with the sealing characteristics of the closure protecting the organizer and the fibers managed within the closure volume from the elements.

The closure 10 extends from a bottom 16 to a top 18 along an axis 20, and the dome cover 12 has a dimension D1 parallel to the axis 20. The base 14 has dimensions D2 and D3 that are perpendicular to each other and perpendicular to the axis 20. The dimensions D2 and D3 define a projection plane perpendicular to the axis 20 onto which a footprint of the organizer projects when positioned within the closure volume and the closure is sealed.

Aspects of the of example organizers described herein can reduce the footprint of the organizer projected in the projection plane, thereby advantageously allowing at least one of the dimensions D2 or D3 to be reduced. To make up for the reduced D2 and/or D3 dimension without sacrificing fiber management volume capability of the organizer, the dimension D1 can be, though need not be, increased. It can be advantageous for cost, regulatory compliance, space saving, and/or weight distribution considerations and limitations, other parameters being equal, for a closure such as the closure 10 to have a smaller profile within and parallel to the projection plane. Lengthening of the dimension D1 can also be advantageous in, e.g., aerially suspending applications, allowing the weight of the suspended closure to be distributed across a greater distance along the dimension D1.

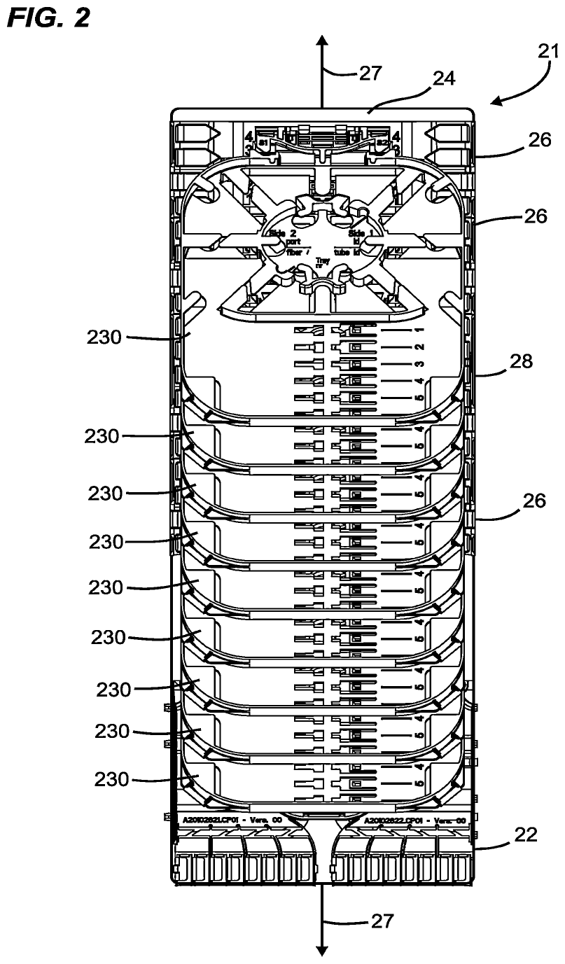

FIG. 2 is a front view of an optical fiber organizer 21 according to the present disclosure and including a fiber routing block 22 connected thereto. The organizer 21 includes a support structure 24. The support structure 24 can include a frame, a backplate or any other supporting structure. The support structure 24 is configured to support modules 26, 28 in a stack of modules along a stacking axis 27. The modules 26, 28 pivotally mount fiber management trays 230. The fiber management trays 230 are of a first form factor that will be described in greater detail below and are configured to support one or more fiber management arrangements, such as excess fiber storage, splice bodies, fiber optic connectors, fiber optic adapters, fiber indexing features, wave division multiplexing features, signal splitter features, etc.

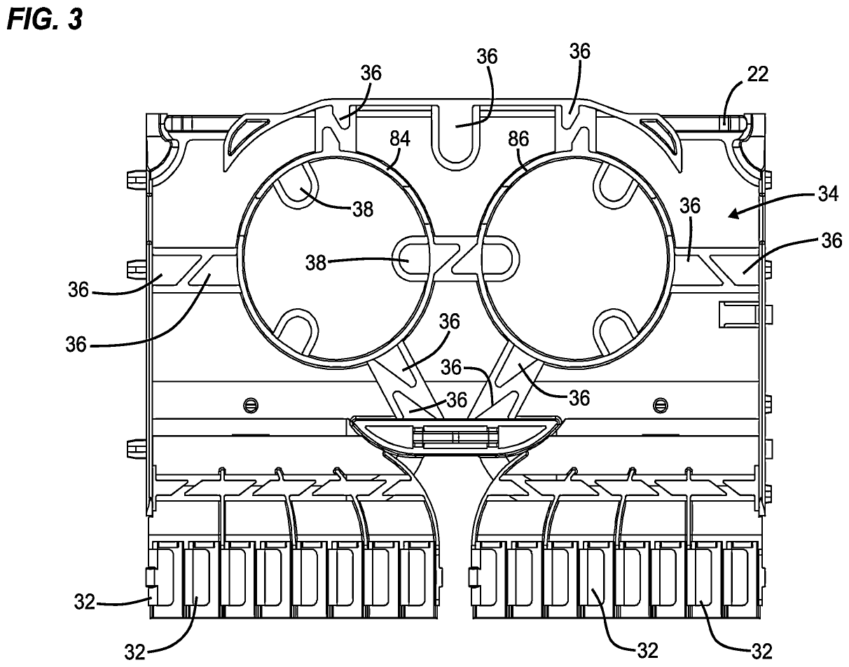

FIG. 3 is a front view of the fiber routing block 22 of FIG. 2. The fiber routing block 22 includes sheath holders 32. Sheaths of optical fibers from cables entering the closure can be secured in sheath holders 32. The fibers extend from the sheaths into the routing area 34 of the block 22. The routing area 34 includes fiber retainer lips 36, 38 and spool structures 84, 86 for storing loops of fiber and routing fibers to one side or another side of the stack of trays. From the block 22, the fibers enter guide channels of the modules of the organizer 21, which guide the fibers to a desired tray 230 on which one or more fiber management tasks can be supported. For example, a fiber from a network side cable can be routed to a given tray 30 along a fiber guide channel at the left of the modules, and another fiber from a subscriber side cable can be routed to the same tray 230 along a fiber guide channel at the right side of the modules, and a splice between the two fibers can be supported by a splice holder held on the tray to which the fibers are routed.

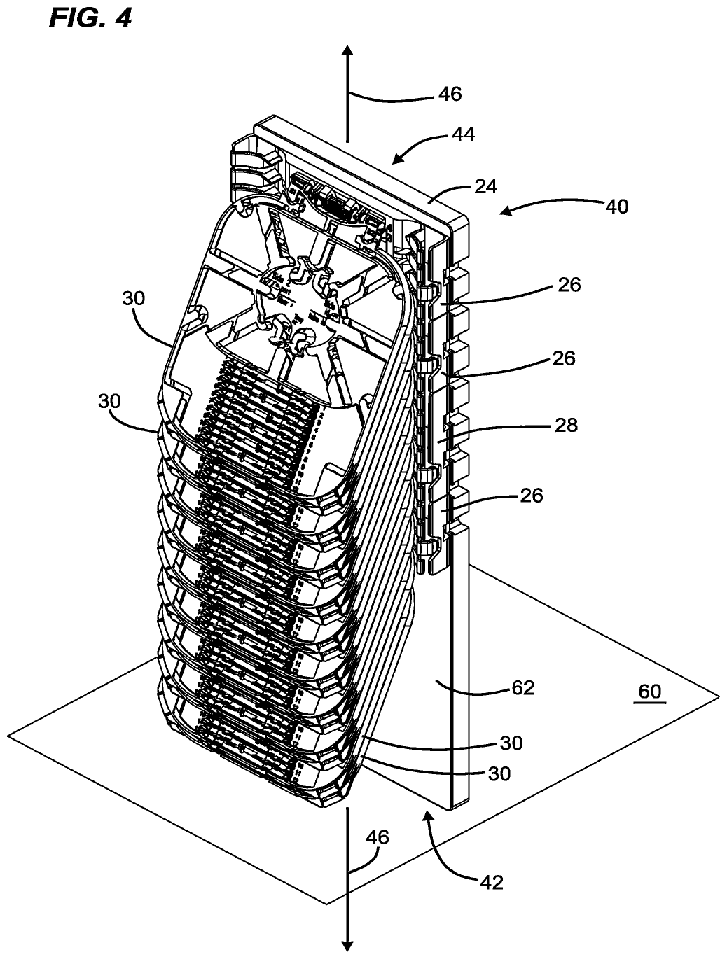

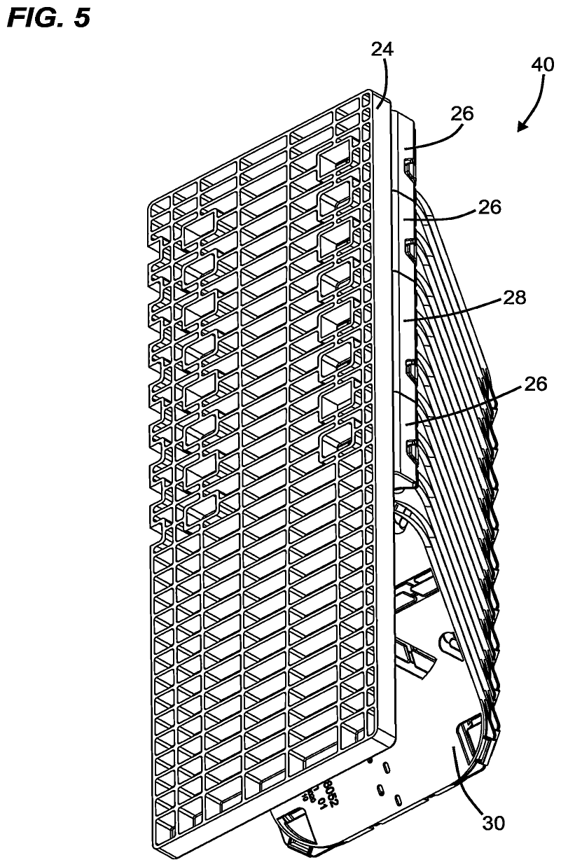

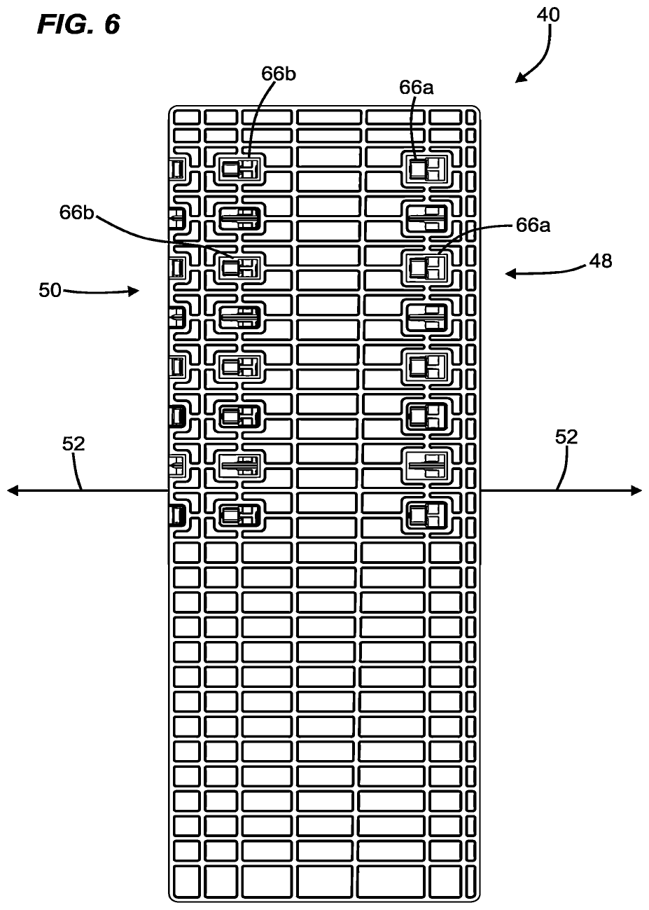

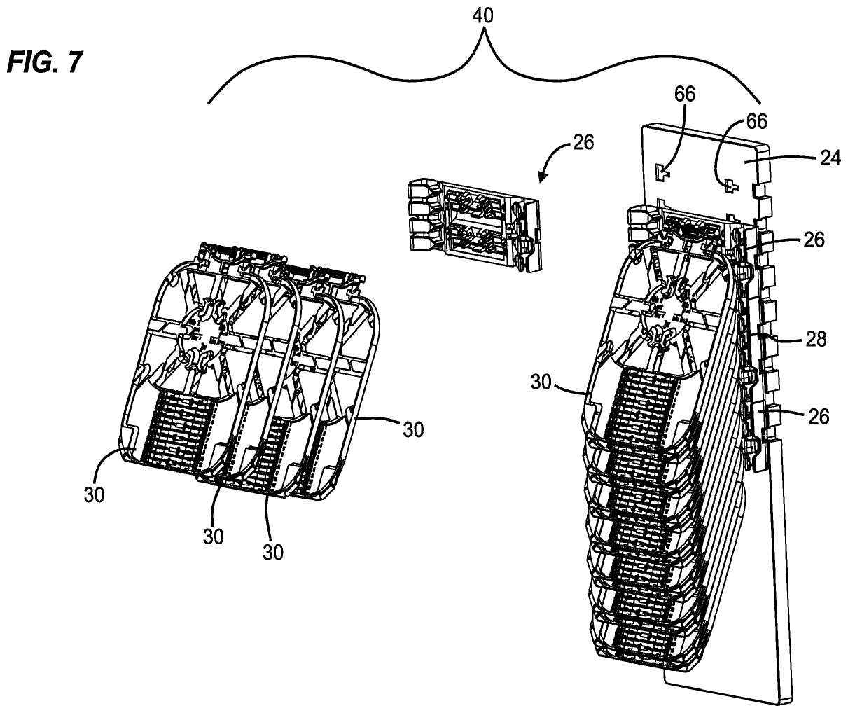

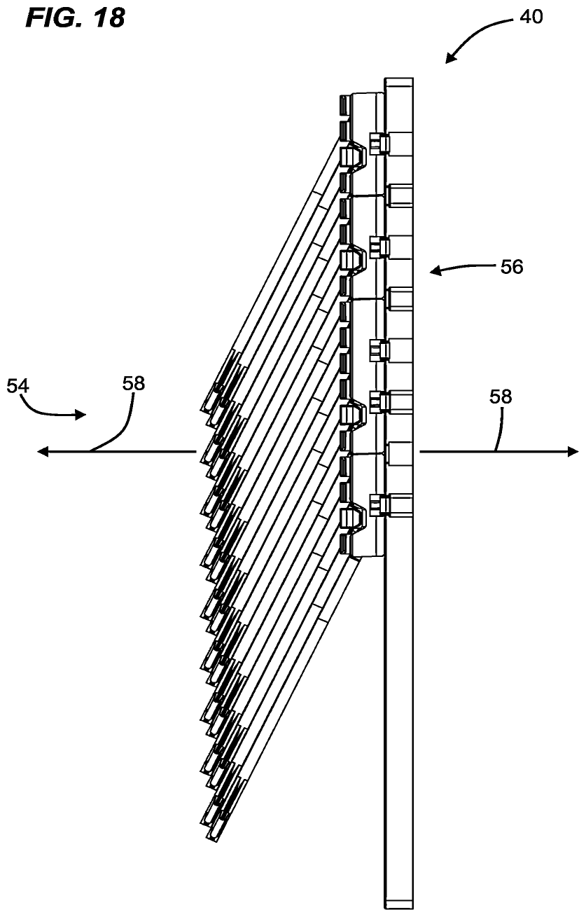

FIG. 4 is a perspective view of an optical fiber organizer 40 according to the present disclosure. The optical fiber organizer 40 is identical to the optical fiber organizer 21 of FIG. 2, except that the optical fiber organizer 40 includes trays 30 having a form factor that is different from the form factor of the trays 230 of FIG. 2. FIG. 5 is a further perspective view of the optical fiber organizer 40 of FIG. 4. FIG. 6 is a back view of the optical fiber organizer 40 of FIG. 4. FIG. 7 is a partially exploded view of the optical fiber organizer 40 of FIG. 4. FIG. 18 is a right side view of the optical fiber organizer of FIG. 4.

Referring to FIGS. 4-7 and 18, the organizer 40 extends from a bottom 42 to a top 44 along a first axis 46. The organizer 40 extends from a left side 48 to a right side 50 along a second axis 52. The organizer 40 extends from a front 54 to a back 56 along a third axis 58. The axes 46, 52 and 58 are all mutually perpendicular. The second and third axes 52 and 58 define a plane that is parallel to a projection plane 60 upon which a footprint or profile of the trays 30 (or trays 230) project when in the pivoted down configuration shown in FIG. 4.

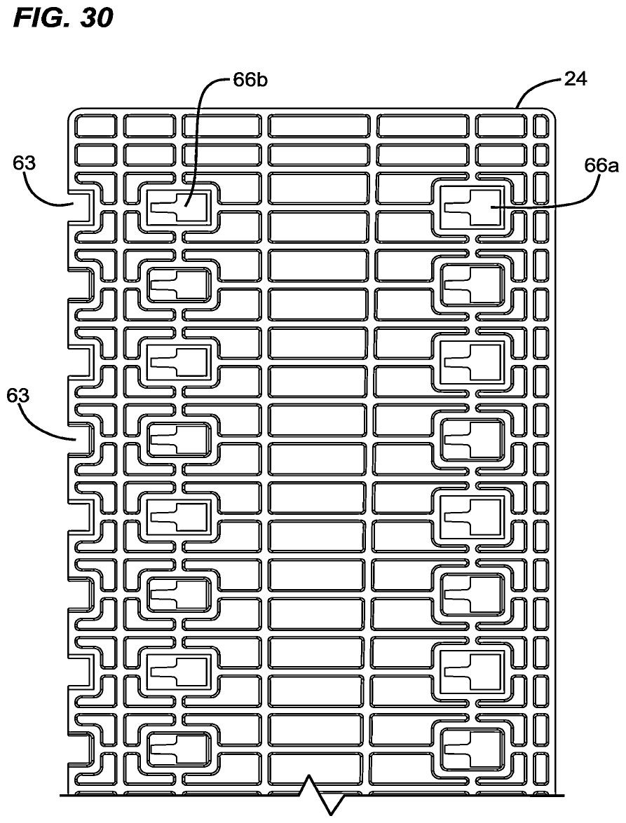

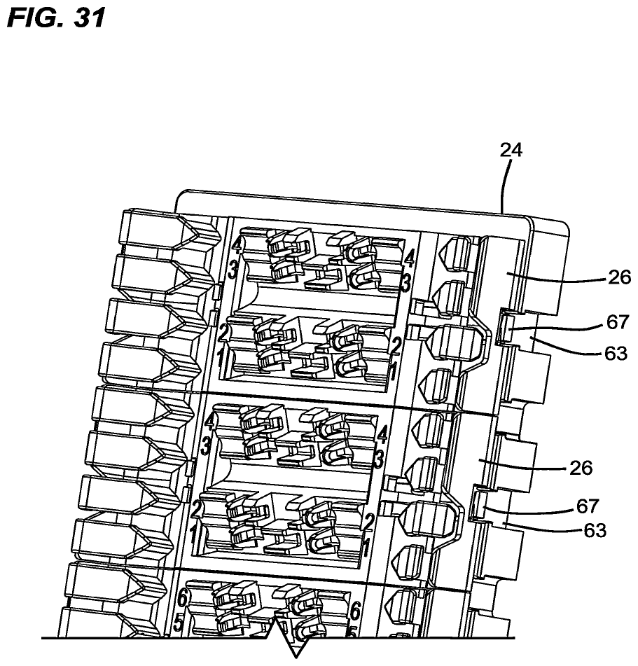

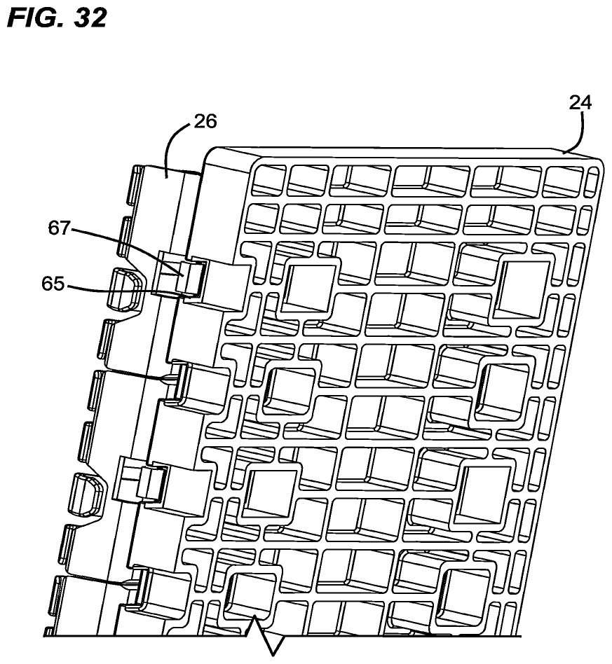

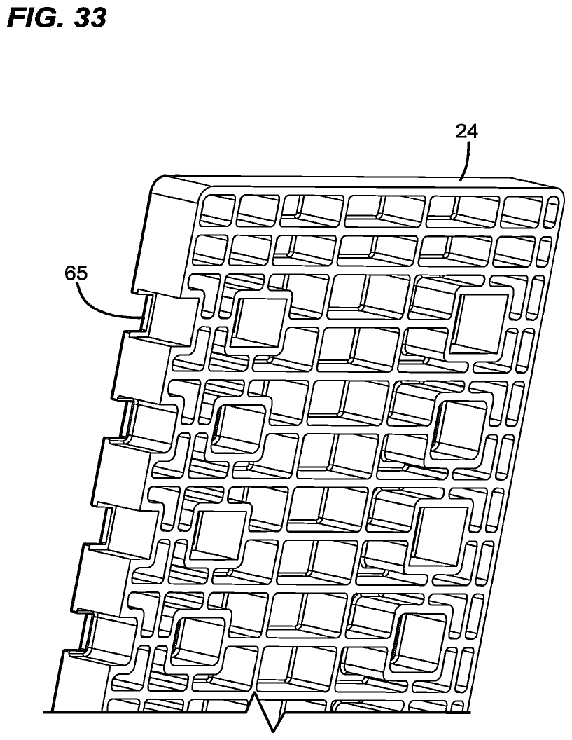

Referring to FIGS. 4-11, 18 and 29-33, the modules 26, 28 mount to the support structure 24 such that the modules 26, 28 extend forwardly from a front surface 62 of a body of the support structure 24. T-shaped projections 64a on the backs of the modules 26, 28 are configured to intermate and slidingly engage in a dovetail fashion with complementary T-shaped openings 66a defined by the support structure 24, and T-shaped projections 64b on the backs of the modules 26, 28 are configured to intermate and slidingly engage in dovetail fashion with complementary openings 66b. The projections 64a are larger than the projections 64b. Correspondingly, the openings 66a are larger than the openings 66b. The openings 66b are too small to accommodate the projections 64a. Therefore, the modules 26, 28 can be mounted in one orientation only to the support structure 24. The support structure 24 defines notches 63. Each notch 63 is aligned with a corresponding opening 66a and a corresponding opening 66b. Each notch 63 defines a lip 65. Each module 26, 28 includes a resilient arm 69 having a catch 67. To securely mount a module 26, 28 to the support structure 24, the projections 64a and 64b of the module 26, 28 are inserted in the wider portions of the openings 66a and 66b, respectively. The module 26, 28 is then slid such that the stems of the T-shape projections enter the narrower portions of the openings 66a and 66b. In addition, the resilient arm 69 flexes such that the catch 67 snappingly and lockingly engages the lip 65 that is aligned with the openings 66a and 66b that have received the projections. Snap engagement of the lip 65 and the catch 67 can inhibit sliding of the projections 64a and 64b back towards the wider portions of the openings 66a and 66b, thereby locking the module 26, 28 to the support structure 24. To unlock a module 26, 28 from the support structure 24 (e.g., to replace a module 26 with a module 28 or vice versa), a tool can be used to flex the arm 69 such that the catch 67 disengages the lip 65, allowing the module 26, 28 to be slid within, and then removed from, the openings 66a and 66b.

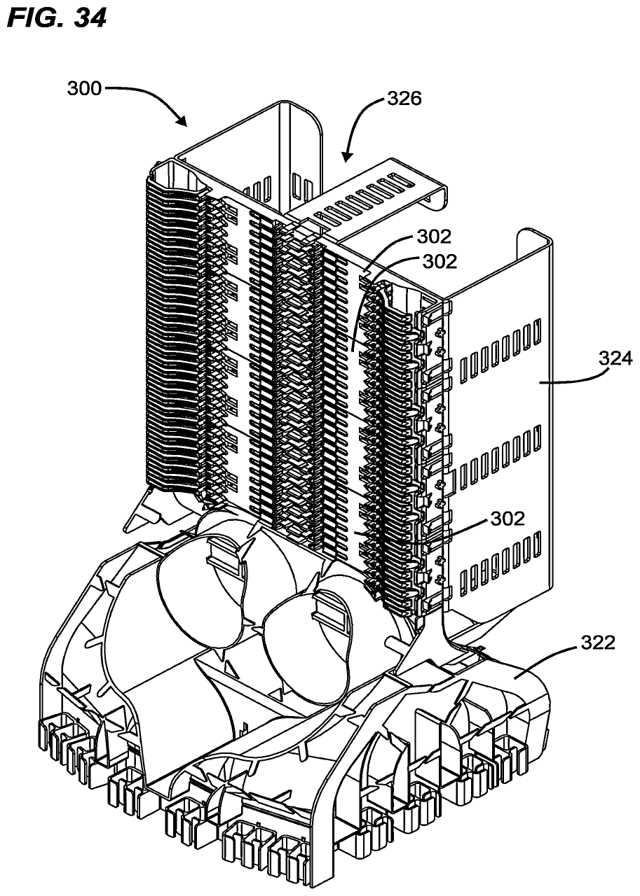

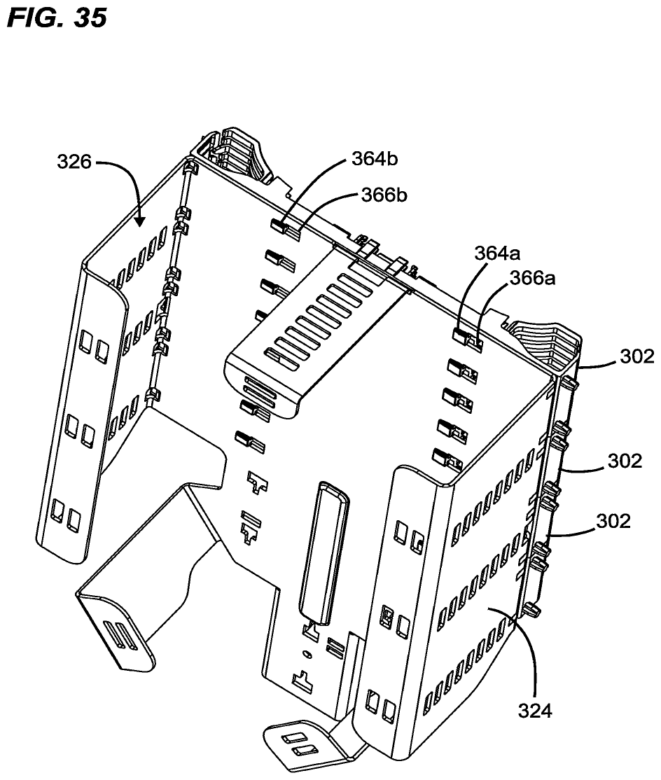

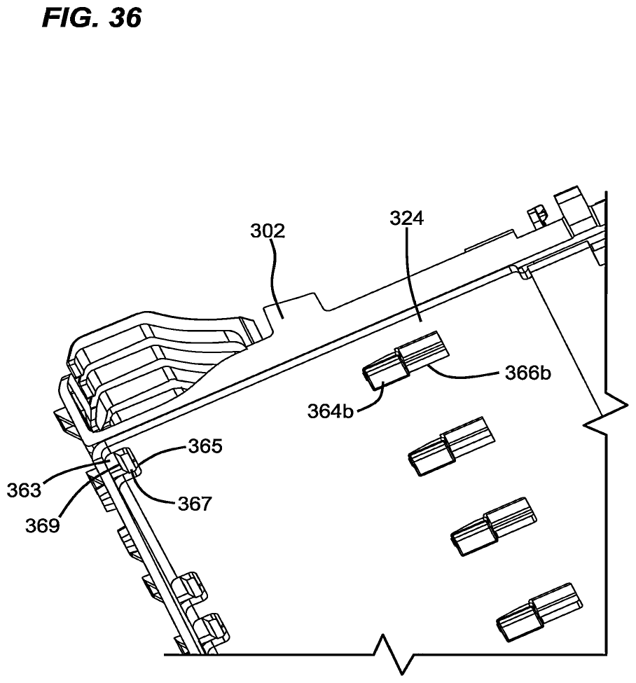

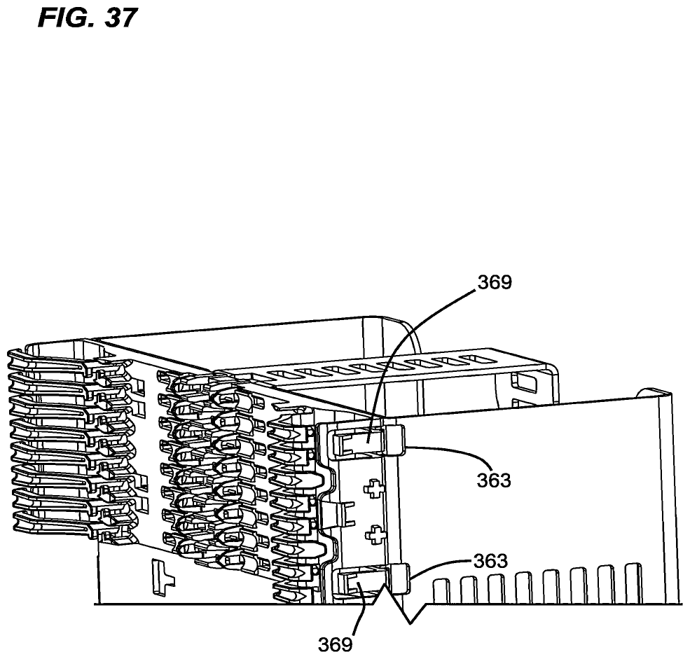

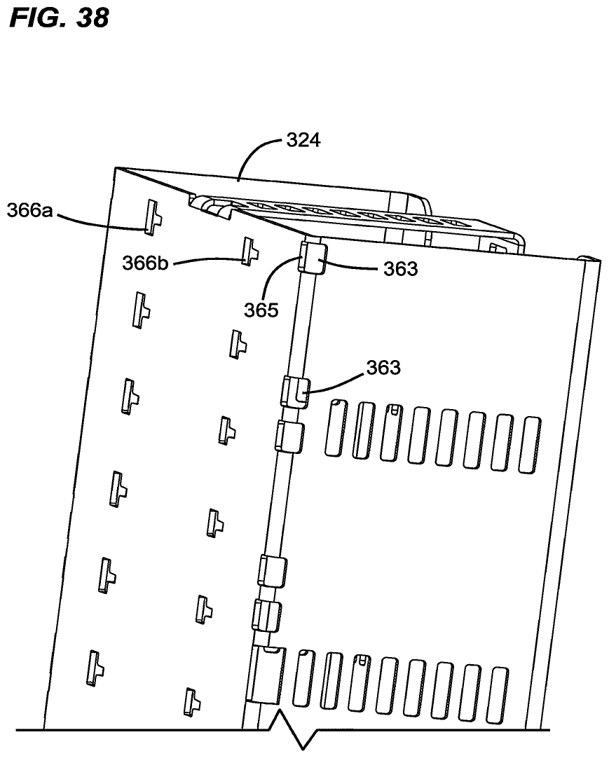

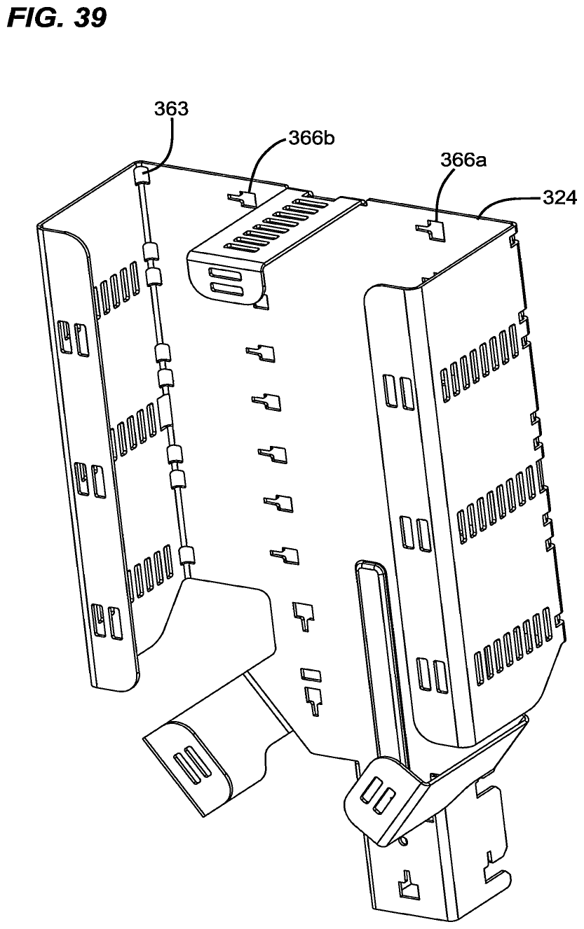

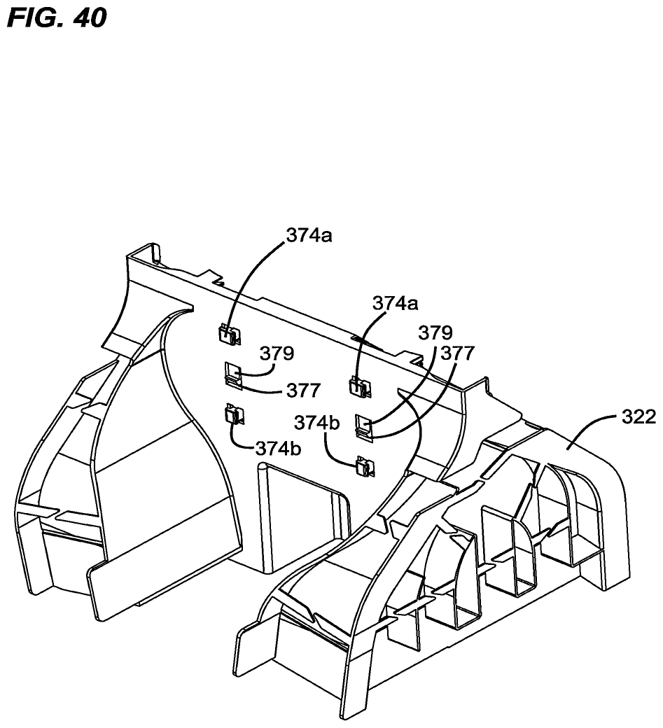

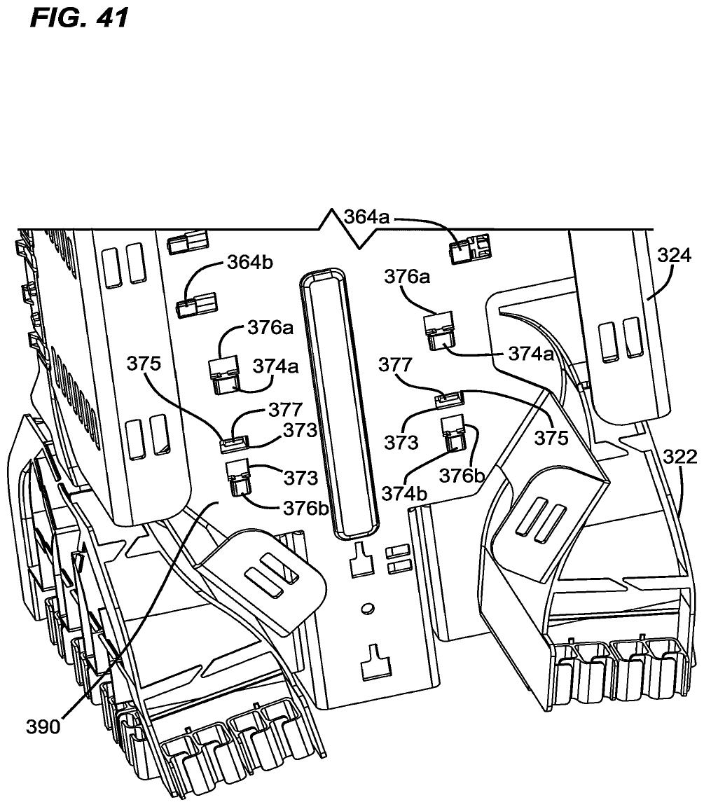

Referring to FIGS. 34-41, a further example fiber management assembly 300 including components having mounting features similar to those just described, is shown.

The fiber management assembly 300 includes a fiber routing block 322, a module support structure 324, and modules 302.

The modules 302 are configured to pivotally support fiber management trays.

The fiber routing block 322 functions similarly to the routing block 22 (FIG. 3) described herein.

The support structure 324 defines a basket 326. The basket 326 is configured to hold, e.g., loops of optical fibers and/or loops of tubes or sheaths containing optical fibers. The basket 326 can serve as storage of the optical fibers of those loops until a later time when the looped portions of the fibers are needed, and/or as storage for portions of fibers that, via cables, enter and exit the closure housing the assembly 300 without being routed to fiber management trays within the closure. Other fiber management uses for the basket 326 are possible. In some examples, the support structure can be constructed of sheet metal.

The modules 302 are lockingly mounted to the support structure 324. In addition, the block 322 is lockingly mounted to the support structure 324. The locking features that lock the modules 302 and the block 322 to the support structure 324 are similar to the locking features described above that lock the modules 26, 28 to the support structure 24 (FIGS. 6, 9, 11, and 29-33). In particular, T-shaped projections 364a on the backs of the modules 302 are configured to intermate and slidingly engage in a dovetail fashion with complementary openings 366a defined by the support structure 24, and T-shaped projections 364b on the backs of the modules 302 are configured to intermate and slidingly engage in dovetail fashion with complementary openings 366b. The projections 364a are larger than the projections 364b. Correspondingly, the openings 366a are larger than the openings 366b. The openings 366b are too small to accommodate the projections 364a. Therefore, the modules 302 can be mounted in one orientation only to the support structure 324. The support structure 324 defines openings 363. Each opening 363 is aligned with a corresponding opening 366a and a corresponding opening 366b. Each opening 363 defines a lip. Each module 302 includes two resilient arms 369 each having a catch 367. To securely mount a module 302 to the support structure 324, the projections 364a and 364b of the module 302 are inserted in the wider portions of the openings 366a and 366b, respectively. The module 302 is then slid such that the stems of the T-shape projections enter the narrower portions of the openings 366a and 366b. In addition, the resilient arms 369 flex such that the catches 367 snappingly and lockingly engage the lips 365 that are aligned with the openings 366a and 366b that have received the projections. Snap engagement of the lips 365 and the catches 367 can inhibit sliding of the projections 364a and 364b back towards the wider portions of the openings 366a and 366b, thereby locking the module 302 to the support structure 324. To unlock a module 302 from the support structure 324 a tool can be used to flex the arms 369 such that the catches 367 disengage the lips 365, allowing the module 302 to be slid within, and then removed from, the openings 366a and 366b.

The block 322 lockingly mounts to the support structure 324 in a similar fashion. T-shaped projections 374a and 374b of the block 322 slide within T-shaped openings 376a and 376b, respectively. The sliding motion is perpendicular to the sliding motion that locks the modules 302 to the support structure 324 described above. Concurrent with the sliding motion, catches 377 of resilient arms 379 of the block 322 snappingly and lockingly engage lips 375 at openings 373 defined by the main mounting plate 390 of the support structure 324. Unlike the modules 26, 28 and 302, each resilient arm 379 and corresponding catch 377 is positioned between the corresponding projections 374a and 374b, rather than to one side.

Referring again to FIGS. 4-11 and 18, any suitable combination of modules 26, 28 can be used and modified for a given organizer. In some examples only one module type—either the module 26 or the module 28 is used.

The modules are 26, 28 are vertically stacked one atop another against the support structure 24 along a stacking axis that is parallel to the axis 46.

In other examples, the modules can be configured to interlock to one another, with or without the aid of a separate support structure.

Each module 26, 28 pivotally mounts fiber management trays. Each module 26 is configured to pivotally mount up to four of the trays 30, or up to two of the trays 230. Each module 28 is configured to pivotally mount up to six of the trays 30, or up to three of the trays 230. Thus, the arrangement of modules 26, 28 of the organizer 40 can pivotally support up to eighteen of the trays 30, or up to nine of the trays 230 (FIGS. 21 and 25). Different arrangements of the modules 26, 28, and/or the use of different modules can support different numbers and/or types of trays.

A hinge pin of each tray is pivotally coupled to one or more tray couplers of a corresponding module 26, 28. The coupling of hinge pin to tray coupler allows the corresponding tray to be pivot about a pivot axis defined by the hinge pin held by the tray coupler(s). The trays 30 in FIGS. 4 and 18-20 are all in their pivoted down position, which is the most the trays 30 can be pivoted downward. Likewise, the trays 230 in FIGS. 21 and 25-27, are all in their pivoted down position.

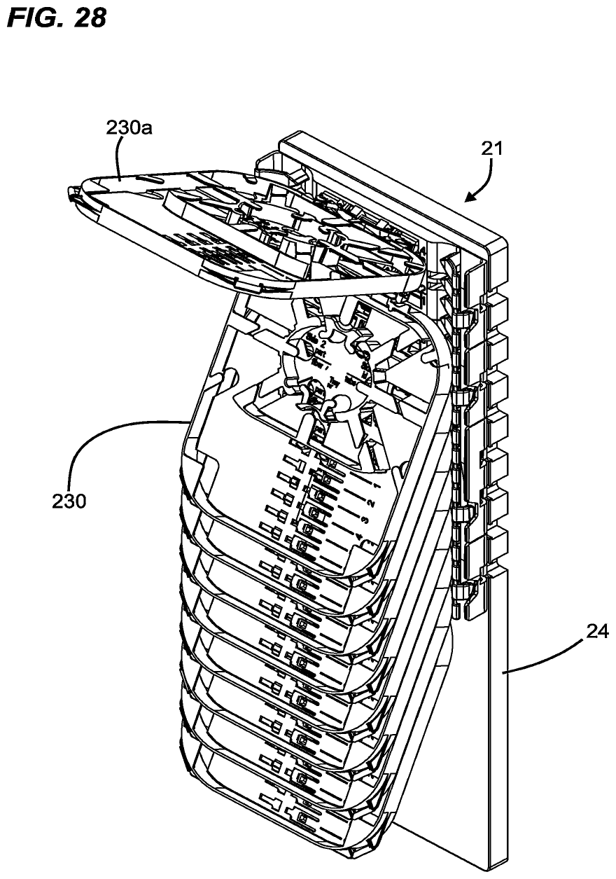

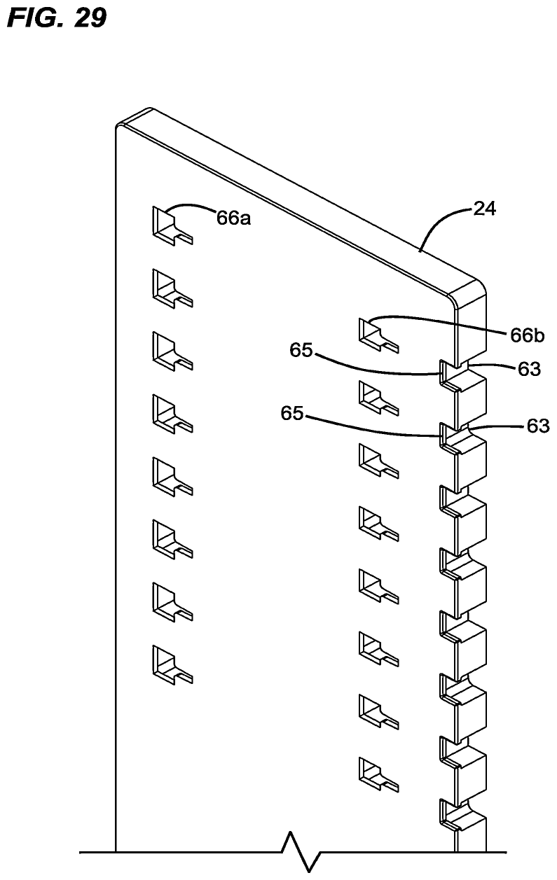

Referring to FIG. 28, the uppermost tray 230 of the organizer 21 is in a pivoted up position. The range of pivot can be e.g., up to, or greater than, 90 degrees between the pivoted down position and the maximum pivoted up position. Features of the pivotal coupling between tray and tray coupler can function as rotation or pivot stops that can, e.g., self-support a tray in a pivoted up position against a gravity force to facilitate access to the fiber management features of a tray below the pivoted up tray.

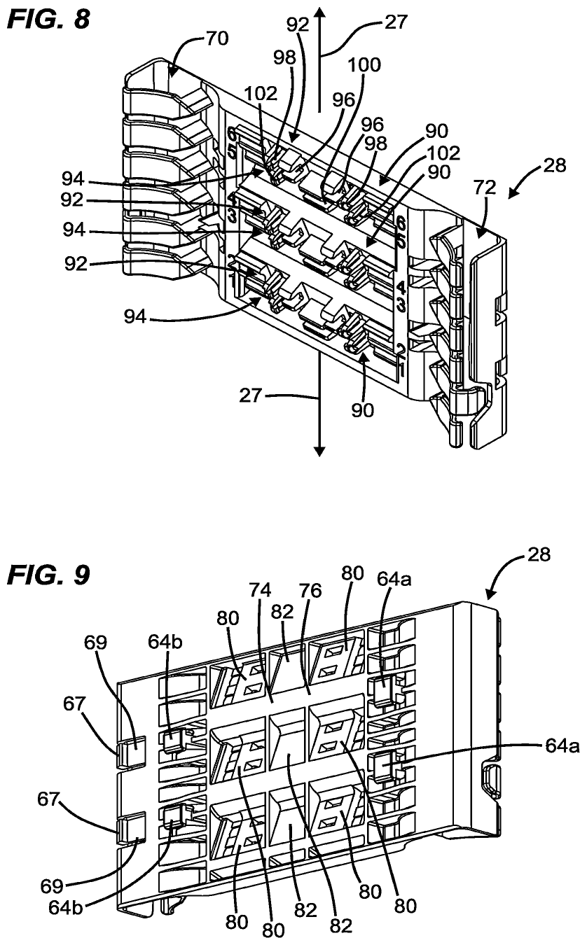

Referring to FIGS. 8-9, the module 28 includes a body 68. The module 28 can be constructed from a molded material, such as a rigid polymer.

The body 68 includes the T-shaped projections 64 and includes left and right fiber guide channels 70, 72. The body includes a backplate 74 that defines a planar surface 76 that is parallel to the stacking axis 27. The stacking axis 27 is parallel to the first axis 46 (FIG. 4.). Other modules such as additional modules 28, modules 26 or other modules, can be stacked with the module 28 along the stacking axis 27 to form a stack of modules.

Tray coupler bases 80, 82 extend forwardly from the planar surface 76 at oblique angles to the stacking axis 27. From the tray coupler bases 80, 82 extend three groups 90 of two tray coupler arrangements each, each tray coupler arrangement defining tray couplers. Each group 90 includes a tray coupler arrangement 92 and a tray coupler arrangement 94 below the tray coupler arrangement 92. Each tray coupler arrangement 92 includes tray couplers that define hinge pin receptacles 96, 98. Each tray coupler arrangement 94 includes tray couplers that define hinge pin receptacles 100, 102. Due to the projection angle of the tray coupler bases 80, 82, the hinge pin receptacles 96, 98 extend forwardly more than the hinge pin receptacles 100, 102 in a given group 90 of tray coupler arrangements 92 and 94. Thus, the tray couplers are presented in a stepped-configuration, with each group 90 forming a step.

The tray couplers 96 are two approximately C-shaped clips that are spaced apart parallel to the second axis 52 (FIG. 6) and configured to pivotally receive a hinge pin of a fiber management tray. The tray coupler 100 is a single approximately C-shaped clip centered relative to the second axis 52 between the tray couplers 96 and configured to receive a hinge pin of a fiber management tray. The tray coupler 100 is wider parallel to the second axis 52 than either of the tray couplers 96. In some examples, the tray coupler 100 is at least twice as a wide parallel to the second axis 52 as each tray coupler 96. The sizing and relative positioning of the tray couplers 96 and 100 in each group of coupler arrangements can generate a centrally balanced coupling of one tray or two trays to the group. In addition, the sizing and relative positioning of the coupler 100 relative to the couplers 96 can minimize or eliminate physical interference between the coupler 100 (the unused coupler) and a thicker tray 230 (FIG. 25) when the thicker tray is in the pivoted down position, when there is only one thicker tray pivotally mounted to the upper tray coupler arrangement in each group and there is no tray coupled to the lower tray coupler arrangement in each group.

The distance parallel to the stacking axis 27 between a tray coupler arrangement 94 of one group 90 and a tray coupler arrangement 92 of the adjacent group 90 is greater than the corresponding distance parallel to the stacking axis 27 between a tray coupler arrangement 92 and a tray coupler arrangement 94 within the same group 90. The relatively larger vertical gap between groups 90 can allow thicker trays 230 to be pivotally mounted to the modules without substantially increasing the projected footprint in the horizontal plane 60 (FIG. 4), with only a single tray 230 pivotally mounted per group 90, rather than two of the thinner trays 30 being pivotally mounted per group 90. The vertical gap between groups 90, and also between adjacent groups 90 of adjacent modules 26, 28 of a stack of modules, can minimize interference of portions of the thicker trays with projecting tray couplers that might otherwise increase the angle of the thicker trays away from the stacking axis in the pivoted down position.

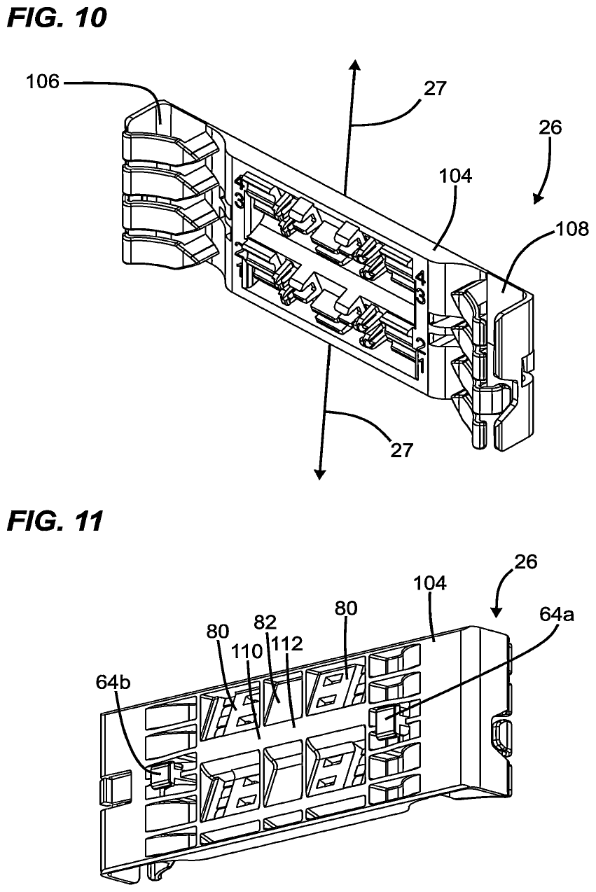

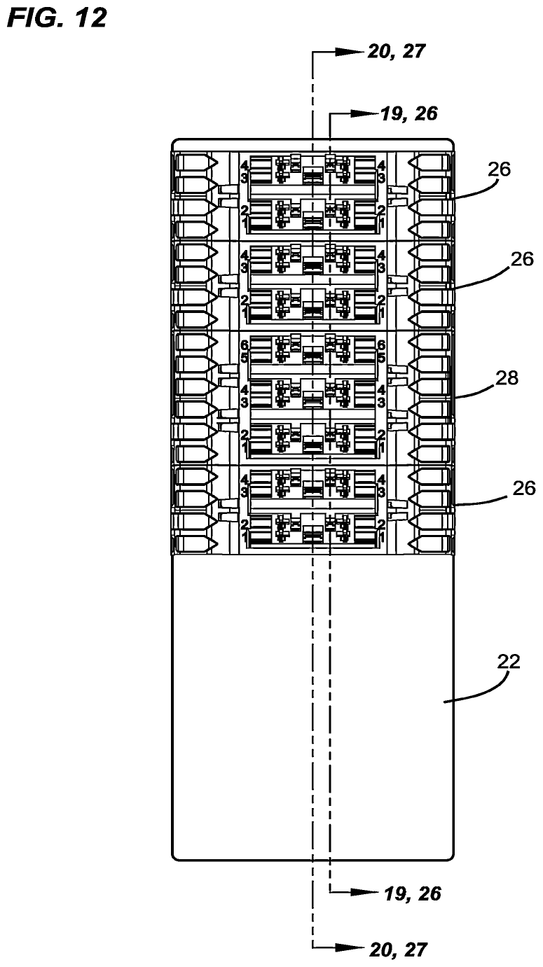

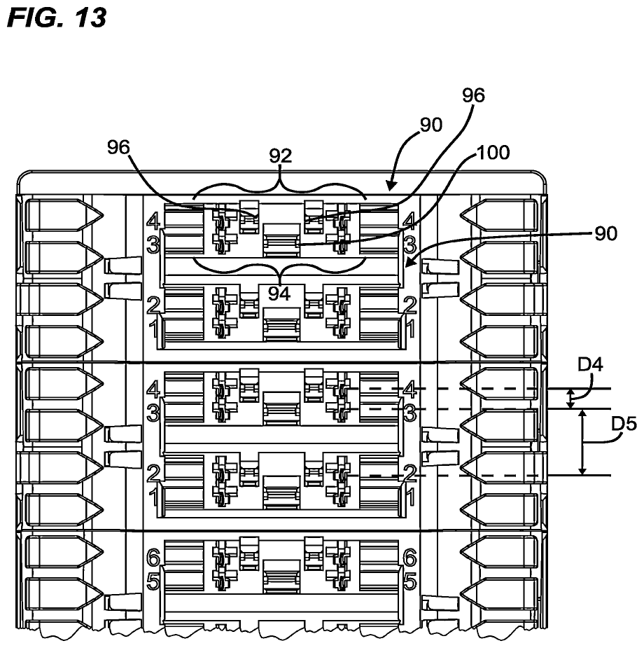

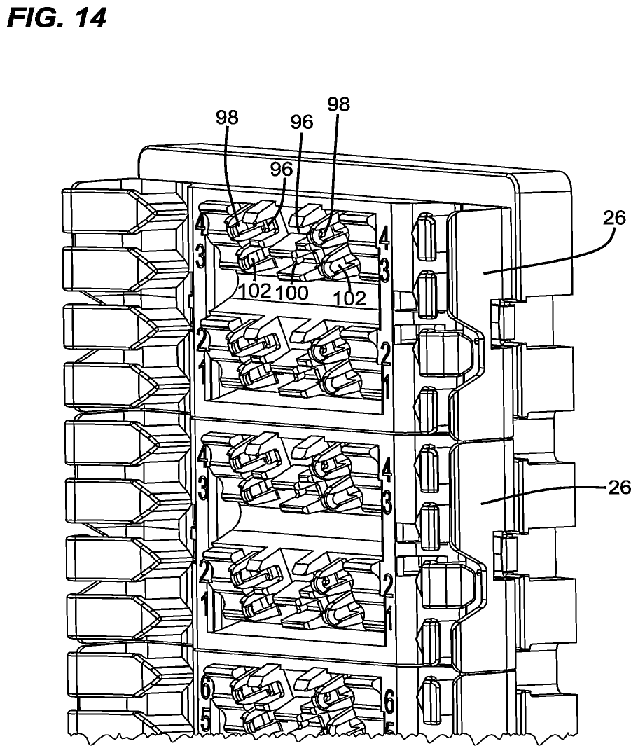

Referring to FIGS. 10, 11, 13 and 14, the module 26 includes a body 104. The module 26 can be constructed from a molded material, such as a rigid polymer. The body 104 includes the T-shaped projections 64 and includes left and right fiber guide channels 106, 108, which align with the fiber guide channels of other modules when the modules are stacked together. The body includes a backplate 110 that defines a planar surface 112 that is parallel to the stacking axis 27. Other modules such as additional modules 26, modules 28 or other modules, can be stacked with the module 26 along the stacking axis 27 to form a stack of modules.

Tray coupler bases 80, 82 extend forwardly from the planar surface 112 at oblique angles (rather than right angles) to the stacking axis 27. From the tray coupler bases 80, 82 extend two groups 90 of two tray coupler arrangements each, each tray coupler arrangement defining tray couplers. Each group 90 includes a tray coupler arrangement 92 and a tray coupler arrangement 94 below the tray coupler arrangement 92. Each tray coupler arrangement 92 includes tray couplers that define hinge pin receptacles 96, 98. Each tray coupler arrangement 94 includes tray couplers that define hinge pin receptacles 100, 102. Due to the projection angle of the tray coupler bases 80, 82, the hinge pin receptacles 96, 98 extend forwardly more than the hinge pin receptacles 100, 102 in a given group 90 of tray coupler arrangements 92 and 94. Thus, the tray couplers are presented in a stepped-configuration, with each group 90 forming a step.

The distance D5 parallel to the stacking axis 27 between a tray coupler arrangement 94 of one group 90 and a tray coupler arrangement 92 of the adjacent group 90 is greater than the corresponding distance D4 parallel to the stacking axis 27 between a tray coupler arrangement 92 and a tray coupler arrangement 94 within the same group 90. The relatively larger vertical gap between groups 90 can allow thicker trays 230 to be pivotally mounted to the modules without substantially increasing the projected footprint in the horizontal plane 60 (FIG. 4), with only a single tray 230 pivotally mounted per group 90, rather than two of the thinner trays 30 being pivotally mounted per group 90. The vertical gap between groups 90, and also between adjacent groups 90 of adjacent modules 26, 28 of a stack of modules, can minimize interference of portions of the thicker trays with projecting tray couplers that might otherwise undesirably increase the angle of the thicker trays away from the stacking axis in the pivoted down position. In some examples, the distance D5 is at least 1.2 times, at least 1.5 times, at least 2.0 times, at least 2.5 times, at least 3.0 times, or at least 5.0 times the distance D4.

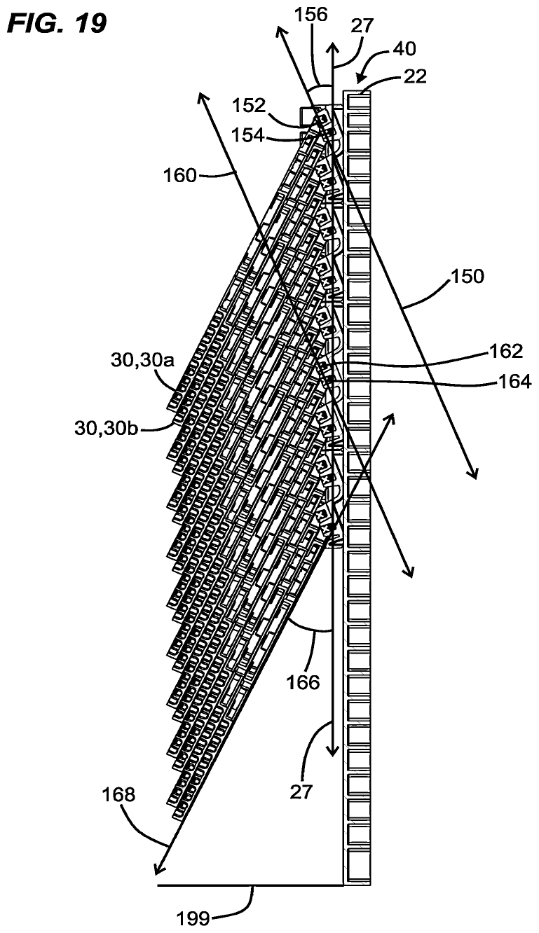

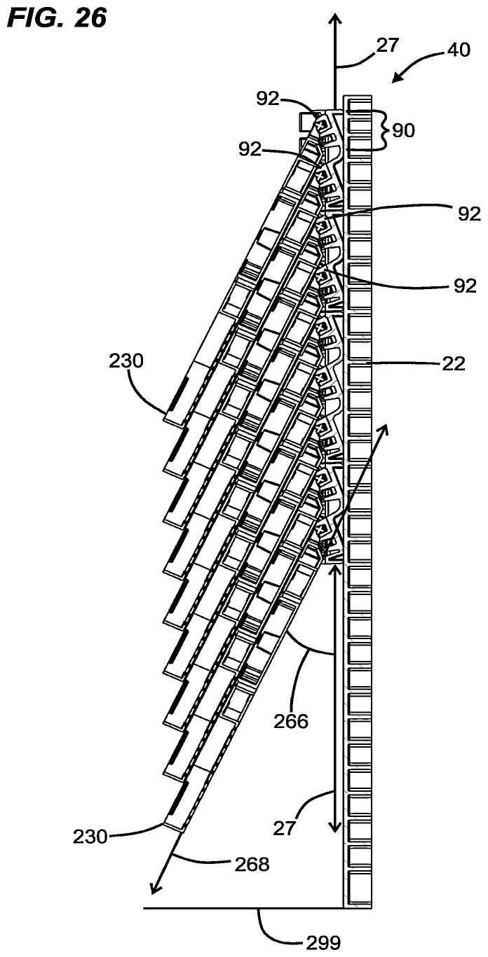

The vertical distance D4 (or pitch) itself between adjacent tray coupler arrangements within each group 90 can also impact the horizontal projection or footprint of the trays mounted to a module 26, 28. For example, by increasing the distance D4, the length of the line 199 (FIG. 19) and the line 299 (FIG. 26) can be reduced while increasing the length of the organizer parallel to the stacking axis. The distance D4 can be selected to minimize this dimension of the horizontal projection while allowing sufficient space for other components (such as a fiber routing block 22) to be positioned between the lowermost of the trays 30, 230 and the support structure 24. To this end, in some examples, the vertical distance D4 between each pair of tray coupler arrangements in each group 90 of tray couplers of each module 26, 28 is greater than at least 7 millimeters, or greater than at least 7.7 millimeters, or greater than at least 9.9 millimeters.

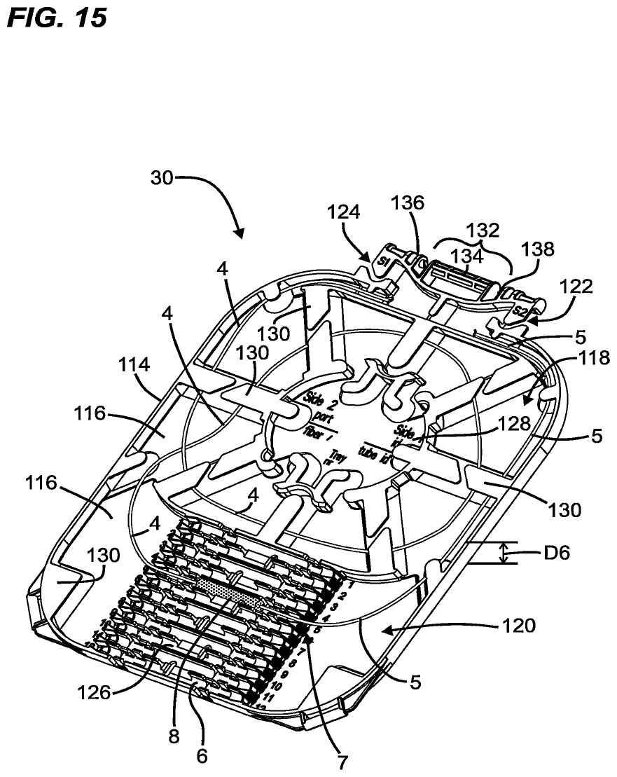

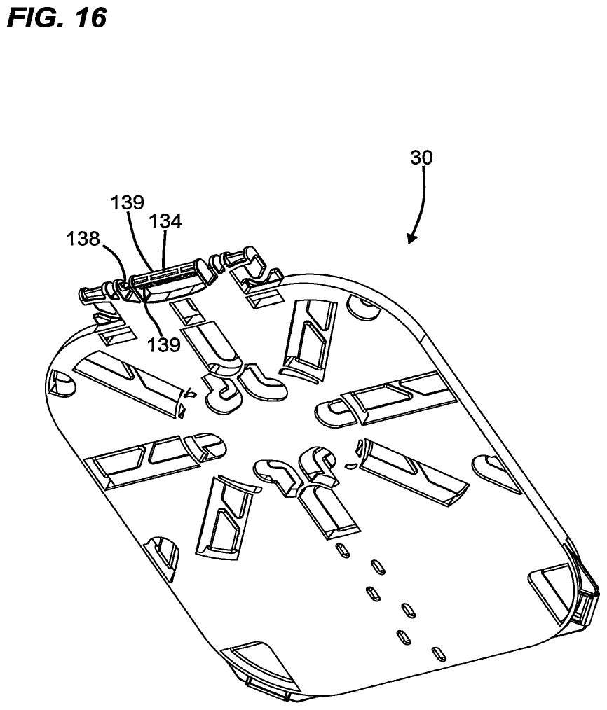

Referring to FIGS. 15-16, the tray 30 includes a tray body 114 defining a fiber management surface 116. The body 114 defines a fiber looping area 118 and a splice holder area 120. Fiber entryways 122, 124 allow fibers from guide channels of a module 26, 28 to enter the tray 30 for management in the fiber looping area 118 and/or the splice holder area 120. The splice holder area includes structures 126 for holding splice bodies. The fiber looping area 118 includes a spool structure 128. Fiber retaining lips 130 can help retain fibers between the lips and the fiber management surface 116. For example, schematically represented fibers 4 and 5 enter and are managed in the tray 30. A splice between the fibers 4 and 5 has a splice body 6 supported in the splice holder 7 of a splice holder block 8. The splice holder block is mounted to the splice holder area 120 of the tray 30.

The tray 30 includes a hinge structure 132 that includes a central hinge pin 134 and two side hinge pins 136, 138 on opposite sides of the central hinge pin. The central hinge pin 134 defines a rectangular prism. The hinge structure 132 pivotally couples to a tray coupler of a module 26, 28. The edges 139 of the hinge central hinge pin 134 act as pivot stops or kick stands as they encounter a surface of a tray coupler of a module 26, 28 to thereby resist rotation of the tray 30 downward due to the force of gravity. The tray 230 has a maximum thickness dimension D6. In some examples, D6 is between about 3 millimeters and about 5 millimeters. In some examples, D6 is approximately 4 millimeters. The thickness D6 can be selected to accommodate management of individual fibers.

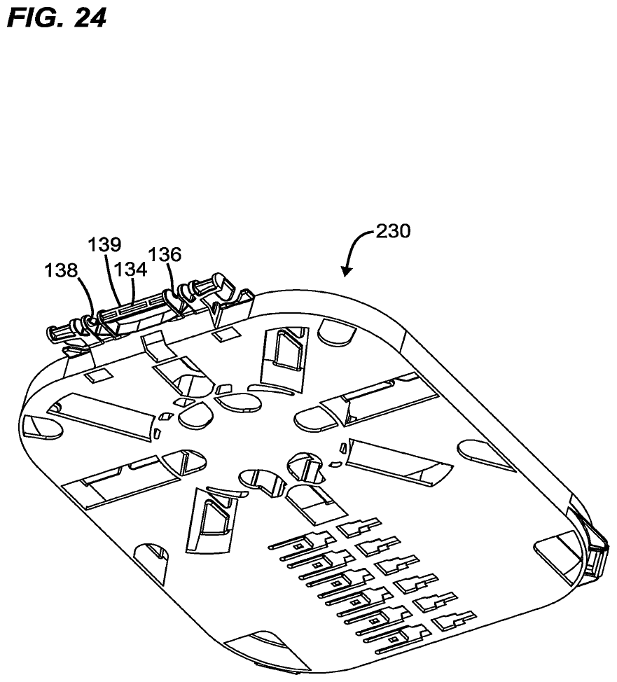

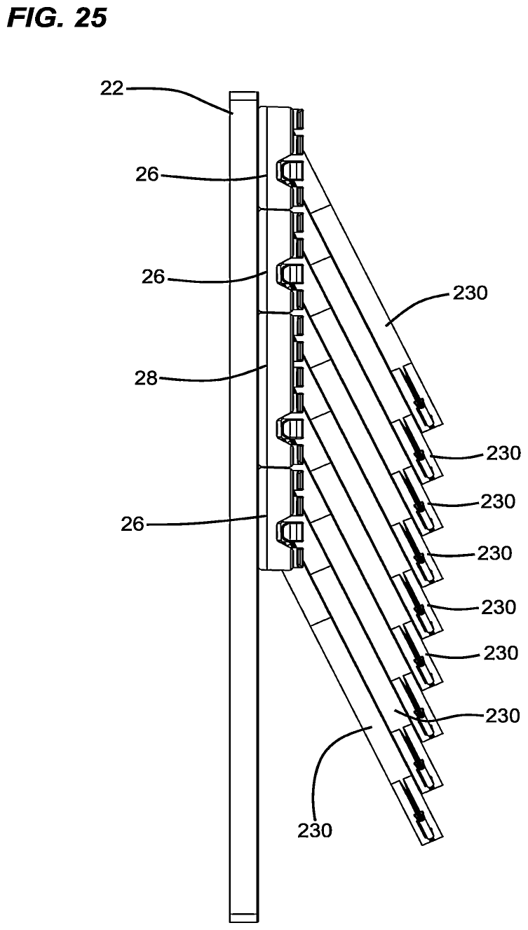

Referring to FIGS. 23-24, the tray 230 includes a tray body 214 defining a fiber management surface 216. The body 214 defines a fiber looping area 218 and a component mounting area 220 (e.g., for mounting splice holders, connectors, adapters, etc.). Fiber entryways 222, 224 allow fibers from a module 26, 28 to enter the tray 230 for management in the fiber looping area 218 and/or the component mounting area 220. The fiber looping area 218 includes a spool structure 228. Fiber retaining lips 226 can help retain fibers between the lips and the fiber management surface 216. The tray 230 includes a hinge structure 132 structurally identical to that of the tray 30 that includes a central hinge pin 134 and two side hinge pins 136 on opposite sides of the central hinge pin. The central hinge pin 134 defines a rectangular prism. The hinge structure 132 pivotally couples to a tray coupler of a module 26, 28. The edges 139 of the central hinge pin 134 act as pivot stops or kick stands as they encounter a surface of a tray coupler of a module 26, 28 to thereby resist rotation of the tray 230 downward due to the force of gravity. The tray 230 has a maximum thickness dimension D7. In some examples, D7 is between about 7 millimeters and about 9 millimeters. In some examples, D7 is approximately 8 millimeters. The thickness D7 can be selected to accommodate management of, e.g. ribbonized fibers and/or connectorized fibers. In some examples, D7 is about twice D6.

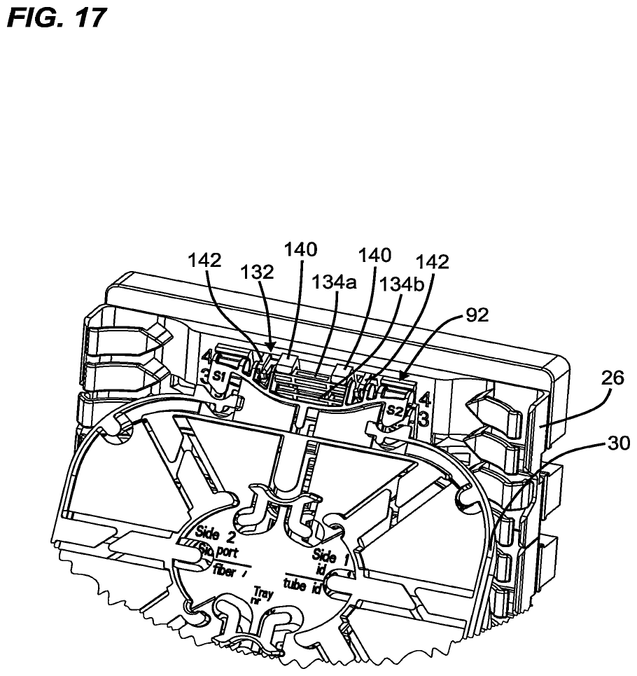

Referring to FIG. 17, the coupling by receipt of a hinge pin structure 132 of a tray 30 by the hinge pin receptacles defined by tray couplers 140, 142 of a tray coupler arrangement 92 of a module 26 is shown. The tray 30 includes a central hinge pin 134a. A lower tray of the same form factor includes a central hinge pin 134b that is pivotally coupled to the tray coupler arrangement immediately below and in the same group of tray couplers. In FIG. 17 the trays are in a pivoted down position.

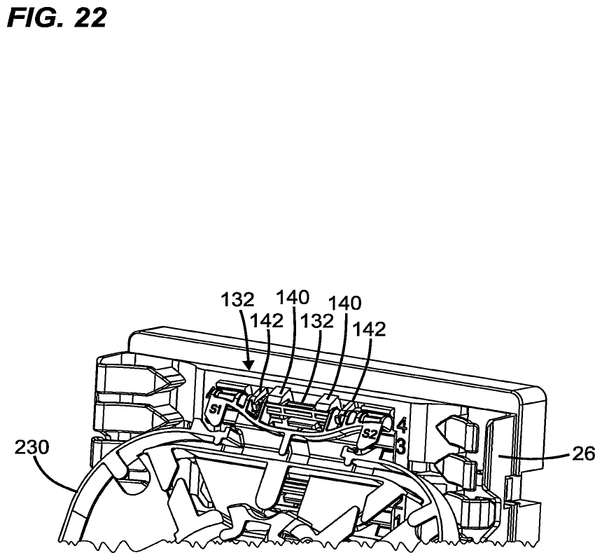

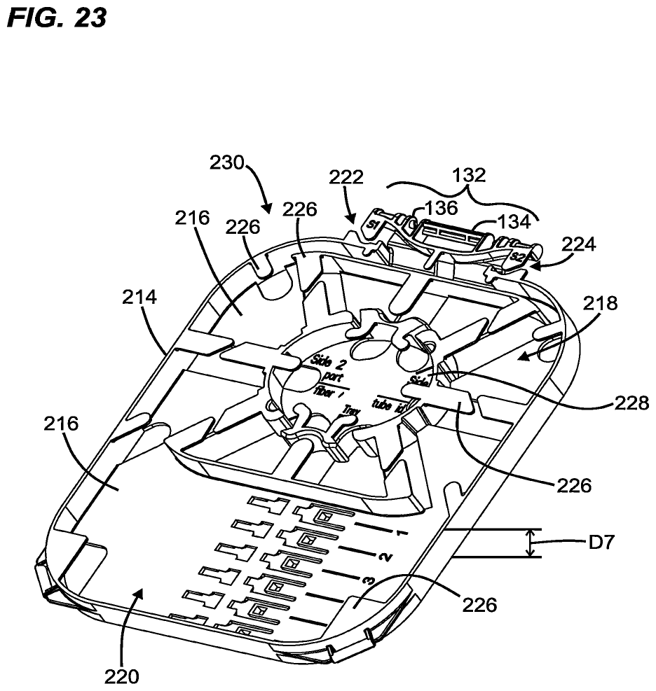

Referring to FIG. 22, the coupling by receipt of a hinge pin structure 132 of a tray 230 by the hinge pin receptacles defined by tray couplers 140, 142 of a tray coupler arrangement 92 of a module 26 is shown. The tray 230 includes a central hinge pin 134 and it is the only tray coupled to tray couplers of that group. In FIG. 22, the tray 230 is in a pivoted down position.

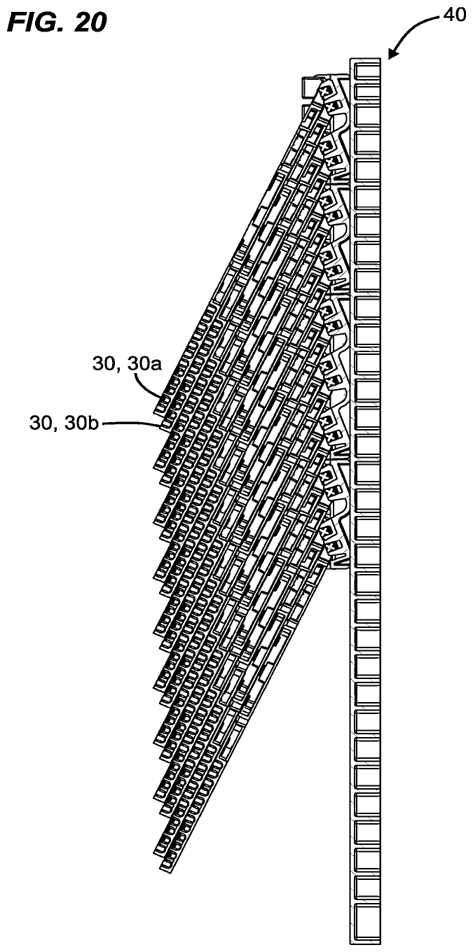

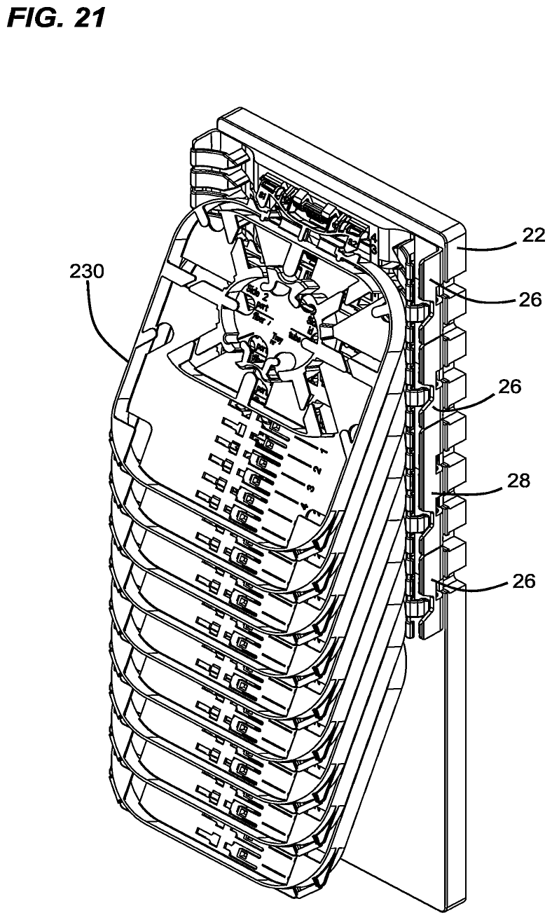

Referring to FIGS. 19 and 20, cross-sections of the organizer 40 pivotally supporting eighteen of the trays 30 all in their pivoted down positions are shown. The eighteen trays 30 are in nine groups of two, each pivotally coupled to its own group of tray couplers of a module 26, 28. One of the groups of trays is enumerated as trays 30a and 30b. One dimension of the entire stack of trays' horizontal projection or profile is schematically represented as the line 199 in FIG. 19.

As shown in FIG. 19, due to the oblique extensions of the tray couplers of the modules and/or the vertical gaps between groups of tray couplers on the modules, a reference line 150 perpendicular to, and extending through, the pivot axis 152 of the tray 30a and the pivot axis 154 of the tray 30b (the pivot axes 152 and 154 are into and out of the page in FIG. 19) is oblique to the stacking axis 27 (the stacking axis is parallel to the first axis 46 (FIG. 4) of the organizer), forming an oblique angle 156. A reference line 150 perpendicular to, and extending through, each pair of pivot axes of each pair of trays of the eighteen trays 30 is parallel to the reference line 150. For example, the reference line 160 through the pivot axes 162 and 164 (into and out of the page in FIG. 19) is parallel to the reference line 150 and forms an oblique angle with the stacking axis 27 of equal magnitude as the magnitude of the angle 156.

In some examples, the angle 156 is between about 5 degrees and about 30 degrees. In some examples, the angle 156 is between about 10 degrees and about 15 degrees. In some examples, the angle 156 is between about 15 degrees and about 25 degrees. In some examples, the angle 156 is about 12 degrees. In some examples, the angle 156 is about 20 degrees. The precise magnitude of the angle 156 can be selected by modifying the extension angle of the tray couplers from the module backplate and/or by modifying the vertical spacing between groups of tray couplers, and/or by modifying the vertical pitch between adjacent tray couplers within the same group.

The reduced projection or profile dimension 199 is a result of a reduced angle 166 defined between the trays 30 in their pivoted down position and the stacking axis 27. The reduced angle 166 is formed between the stacking axis 27 (or a parallel axis) and a plane 168 defined by the fiber management surface of a tray 30 and extending into and out of the page in FIG. 19. The reduced angle 166 is due to the oblique extensions of the tray couplers of the modules and/or the vertical gaps between groups of tray couplers on the modules. In some examples, the reduced angle 166 is less than degrees and greater than 0 degrees. In some examples, the angle 166 is between about 20 degrees and about 35 degrees. In some examples, the angle 166 is about 25 degrees. In some examples, the angle 166 is about 33 degrees. A module for an organizer can be selected based on resulting angle 166 that would be created.

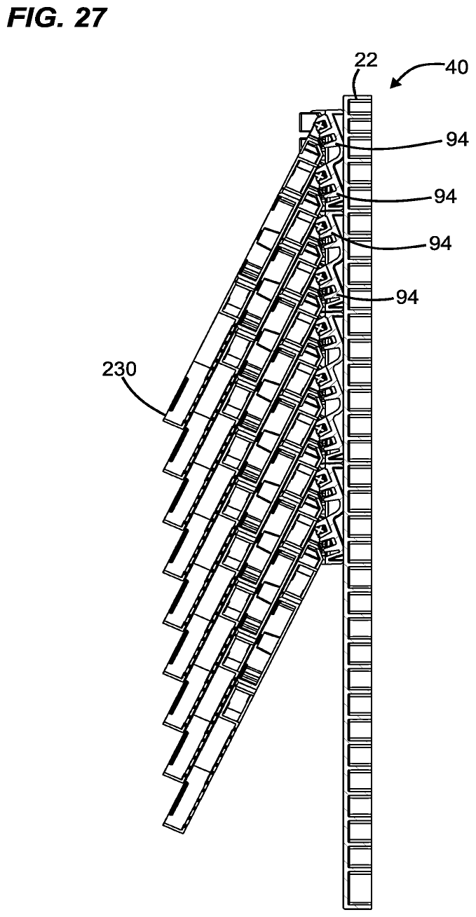

Referring to FIGS. 26 and 27, cross-sections of the organizer 40 pivotally supporting nine of the trays 230 all in their pivoted down positions are shown. Only one tray 230 is coupled to a tray coupler arrangement 92 in each group 90 on each module 26, 28, such that the lower tray coupler 94 in each group 90 is skipped and does not pivotally couple a tray 230. Due to the skipped coupling arrangements 94 and the recessed nature of the coupling arrangements 94 relative to the coupling arrangements 92, there is enough clearance such that the trays 230, in their pivoted down position, and despite being thicker than the trays 30, produce a reduced horizontal projection or profile. A dimension of the entire stack of trays' horizontal projection or profile is schematically represented as the line 299 in FIG. 26. In some examples, the length of the line 299 is equal to, or within 5 percent of, or within 10 percent of, the length of the line 199 (FIG. 19). That is, the module configuration and arrangement is configured to support both thick and thin trays both with reduced horizontal profile in the pivoted down position.

The reduced projection or profile dimension 299 is a result of a reduced angle 266 defined between the trays 230 in their pivoted down position and the stacking axis 27. The reduced angle 266 is formed between the stacking axis 27 (or a parallel axis) and a plane 268 defined by the fiber management surface of a tray 30 and extending into and out of the page in FIG. 26. The reduced angle 266 is due to the stepped configuration of the groups of tray couplers of the modules and/or the vertical gaps between groups of tray couplers on the modules. In some examples, the reduced angle 266 is less than 45 degrees and greater than 0 degrees. In some examples, the angle 266 is between about 20 degrees and about 35 degrees. In some examples, the angle 266 is about 25 degrees. In some examples, the angle 266 is about 33 degrees. In some examples, the angle 266 is equal to, or within 5 degrees, or within 10 degrees, or within degrees, of the angle 166 (FIG. 19). A module for an organizer can be selected based on the resulting angle 266 that would be created.

Various modifications and alterations of this disclosure will become apparent to those skilled in the art without departing from the scope and spirit of this disclosure, and it should be understood that the scope of this disclosure is not to be unduly limited to the illustrative examples set forth herein.

1-2. (canceled)

3. An optical fiber organizer for an optical fiber closure, comprising,
a module defining a first axis extending between a bottom of the module and a top of the module, a second axis extending between a left side of the module and a right side of the module, and a third axis extending between a front of the module and a back of the module, the first axis, the second axis, and the third axis being mutually perpendicular to one another, the module including a body defining tray couplers, each of the tray couplers being adapted to pivotally mount, about a pivot axis, an optical fiber management tray, the module being configured such that a first reference line perpendicular to, and extending through, at least two of the pivot axes of the module is oblique to the first axis.

4. The optical fiber organizer of claim 3, the body of the module including:
a backplate defining a planar surface; and
a hinge pin receptacle defined by each of the tray couplers, a first of the hinge pin receptacles projecting forwardly relative to the planar surface more than a second of the hinge pin receptacles,
wherein the first of the hinge pin receptacles is above the second of the hinge pin receptacles relative to the first axis; and
wherein the tray couplers extend from tray coupler bases, the tray coupler bases extending from the backplate at an oblique angle to the planar surface.

5-6. (canceled)

7. The optical fiber organizer of claim 3,
wherein the module includes groups of the tray couplers for pivotally mounting groups of fiber management trays;
wherein for each of the groups of tray couplers, a second reference line perpendicular to, and extending through, the pivot axes is oblique to the first axis; and
wherein the second reference lines are parallel to each other.

8. The optical fiber organizer of claim 7, wherein each of the groups of the tray couplers is configured to mount a group of no more than two fiber management trays.

9. (canceled)

10. The optical fiber organizer of claim 7, wherein adjacent tray couplers in adjacent groups of tray couplers are separated parallel to the first axis by a greater distance than adjacent tray couplers of the same group of tray couplers.

11. (canceled)

12. The optical fiber organizer of claim 7, including
a backplate defining a planar surface;
optical fiber management trays; and
a hinge pin receptacle defined by each of the trays,
wherein for each of the groups, a first of the hinge pin receptacles is above a second of the hinge pin receptacles relative to the first axis and the first of the hinge pin receptacles projects forwardly relative to the planar surface more than the second of the hinge pin receptacles.

13. The optical fiber organizer of claim 3, wherein the first reference line and the first axis define a first angle, the first angle being between about 5 degrees and about 30 degrees.

14-16. (canceled)

17. An optical fiber organizer for an optical fiber closure, comprising:
a module defining a first axis extending between a bottom of the module and a top of the module, a second axis extending between a left side of the module and a right side of the module, and a third axis extending between a front of the module and a back of the module, the first axis, the second axis, and the third axis being mutually perpendicular to one another, the module including a body defining tray couplers, each of the tray couplers being adapted to pivotally mount, about a pivot axis, an optical fiber management tray,
the body of the module including a backplate defining a planar surface and a hinge pin receptacle defined by each of the tray couplers, the hinge pin receptacle of one of the tray couplers projecting forwardly relative to the planar surface more than the hinge pin receptacle of another of the tray couplers.

18. The optical fiber organizer of claim 17,
wherein the module includes structurally identical groups of the tray couplers for pivotally mounting groups of fiber management trays;
wherein in each of the groups an upper of the hinge pin receptacles projects forwardly relative to the planar surface more than a lower of the hinge pin receptacles, and
wherein each of the groups of the tray couplers is configured to mount a group of no more than two fiber management trays.

19-20. (canceled)

21. The optical fiber organizer of claim 18,
wherein adjacent groups are separated from each other parallel to the first axis; and
wherein adjacent tray couplers of adjacent groups are separated parallel to the first axis by a greater distance than adjacent tray couplers of the same group.

22-24. (canceled)

25. The optical fiber organizer of claim 3,
further comprising a fiber management tray having a hinge pin pivotally mounted to a tray coupler of the module,
wherein the module defines fiber guide channels perpendicular to the pivot axes;
wherein the module is arranged in a stack of modules stacked along the first axis; and
wherein the stack is supported by a stack support.

26-27. (canceled)

28. The optical fiber organizer of claim 18, further comprising:
two structurally identical thin fiber management trays each having a first maximum height dimension perpendicular to a fiber management surface of each thin fiber management tray; and
two structurally identical thick fiber management trays each having a second maximum height dimension perpendicular to a fiber management surface of each thick fiber management tray, the second maximum height dimension being greater than the first maximum height dimension,
wherein the groups of the tray couplers are configured such that:
when the two thin fiber management trays are pivotally mounted to the tray couplers of one of the groups and the trays are in a downward most pivot position, each fiber management surface of each thin fiber management tray defines a first plane that forms a first oblique angle with the first axis;
when one of the thick fiber management trays is pivotally mounted to the upper tray coupler of one of the groups of tray couplers of the module and is in a downward most pivot position and the other of the thick fiber management trays is pivotally mounted to the upper tray coupler of an adjacent group of the tray couplers of the module and in a downward most pivot position, and there is no fiber management tray pivotally mounted between the two thick fiber management trays, each fiber management surface of each thick fiber management tray defines a second plane that forms a second oblique angle with the first axis,
wherein the first oblique angle and the second oblique angle are equal.

29-40. (canceled)

41. The optical fiber organizer of claim 3, wherein a minimum pitch parallel to the first axis between adjacent tray couplers is at least 7 millimeters.

42-54. (canceled)

55. The optical fiber organizer of claim 7,
wherein each group includes a first coupler arrangement having two spaced apart clips and a second coupler arrangement having a single clip below and centered relative to the clips of the first arrangement.

56. The optical fiber organizer of claim 55, wherein the single clip has a width that is larger than a corresponding width of either of the two spaced apart clips.

57. (canceled)

58. The organizer of claim 3, further comprising a support structure configured to lockingly engage each module, the support structure including an opening configured to receive a T-shaped projection of the module, and a lip configured to snappingly engage a catch of a resilient arm of a module when the T-shaped projection is slid toward a narrower portion of the opening.

59-61. (canceled)

62. An optical fiber organizer for an optical fiber closure, comprising:
a fiber management module including a substantially T-shaped projection and one of a lip or a resilient arm having a catch; and
a structure including an opening and the other of a lip or a resilient arm having a catch,
the fiber management module and the structure being configured to lockingly engage each other by sliding the T-shaped projection within the opening towards a narrow portion of the opening and snappingly engaging the lip and the catch.

63-64. (canceled)

65. The organizer of claim 62, wherein the fiber management module is configured to pivotally support fiber management trays.

66. The organizer of claim 62, wherein the structure includes a basket configured to store loops of fibers.

67. The organizer of claim 62, wherein the fiber management module includes a fiber routing block, the fiber routing block supporting fiber tube holders, and defining fiber routing channels and fiber spool structures.
